(19) United States
(12) Patent Application Publication
(10) Pub. No.: US 2010/0138561 A1
(43) Pub. Date: Jun. 3, 2010

(54) SIMULCAST INTERNET MEDIA DISTRIBUTION SYSTEM AND METHOD

(76) Inventor: Michael Wayne Church, Severn Bridge (CA)

Correspondence Address: Tarolli, Sundheim, Covell & Tummino LLP/Harris;Corporation, 1300 East Ninth Street, Suite 1700, Cleveland, OH, 44114, US

(21) Appl. No.: 12/519,318

(22) PCT Filed: Jan. 26, 2007
(86) PCT No.: PCT/US2007/002255

§ 371 Date: Nov. 18, 2009

Related U.S. Application Data
(63) Continuation-in-part of application No. 11/341,333, filed on Jan. 27, 2006.

(51) Int. Cl. G06F 15/16

(52) U.S. Cl. 709/248; 725/110

(57) ABSTRACT

A simulcast Internet media distribution system and method for the same is disclosed in which the present creates an enhanced multimedia viewing experience by creating multiple coordinated media channels synchronized to a primary media channel. The media channels are coordinated by a caching and distribution system optimized for distribution over the Internet.

### FIELD OF THE INVENTION

The present invention is directed to an apparatus and method to distribute or broadcast supplementary media channels in synchronization with a primary media channel, such as television or radiobroadcast.

### BACKGROUND OF THE INVENTION

It was found that in the field of multimedia content distribution, the streaming mechanisms used to distribute media, and in particular simulcast media designed to coordinate real time broadcasts such as television or radio signals with other multimedia events, to the client suffered from unacceptable lack of synchronization. Early attempts to avoid this problem through simple pre-caching were attempted but still suffered from unacceptable drift or lack of synchronization.

The performance requirements for synchronizing multimedia presentations are somewhat subjective, but it is generally accepted in the industry that synchronization within one second is required to produce an acceptable user experience. It is important to note that while the current invention was designed to solve synchronization issues where the requirements are near one second, the same innovative techniques could easily be applied to situations where the synchronization requirements are very different, for example, where the synchronization requirements are in the order of milliseconds.

Since the simulcast media needed to stay in synchronization within one second, the buffering and drift inherent in these existing internet streaming technologies needed to be overcome. In developing the present system, Desktopbox™, it was determined that supplementary synchronized internet media signals could be broadcast alongside a primary broadcast such as television or radio. The challenge with this medium is the synchronization issues to keep the two signals within one second of each other across a medium with highly variable delays such as the Internet. The creation of supplementary and primary media streams is possible by building an interface on top of existing streaming media protocols such as RealAudio™ and Window Media™ player.

The present invention gives television and radio broadcasters an added opportunity to see a return on their programming license fee/rights fee investments. Television and radio programmers and producers who apply the present invention to their shows will enhance viewing by providing layers of in-depth information about the primary media channel that the viewer is experiencing.

Multiple specialty or narrowcast channels can be added to the viewing experience, creating a highly personalized information set, and further increasing the opportunities for revenue generation and promotion.

While a clearly advantageous aspect of the current invention is to synchronize new media such as web content to traditional broadcasting such as television or radio, it is within the anticipated scope of this invention to permit multiple synchronizations between many types of time based and static media and devices such as broadcast television or radio, multimedia files, audio files, pictures, web pages, computer games, PDAs, mobile phones, musical instruments, and specialized databases.

### SUMMARY OF THE INVENTION

The present invention provides network operators, content providers and independent developers with the integrated content publishing software environment to rapidly transform standard web-based content into media rich, dynamic, broadcast ready interactive applications. The system and software combines the latest iTV technology with standard Internet protocols, for example XML and HTTP, to create compelling interactive applications, built for multi viewport interactive television.

Preferably, the present invention includes a server and runtime architecture to provide the benefits of XML authoring while delivering efficient, flexible and robust multi viewport interactive applications.

In one aspect, the present invention provides network based applications that in conjunction with standard software such as web browsers and networked server computers, support automatic, dynamic content updates, such that the information displayed on a viewer's computer screen is always up-to-date. As dynamic information changes at the content source, for example sports scores or stock quotes, the present invention is adapted to quickly access the application pages retrieving the latest data available. This data may be an enhanced television application, accessed through a virtual channel, or from some other data source.

In a preferred embodiment, the present invention provides an option to create static broadcast files ready to broadcast through the system or other server systems. While the benefits of dynamic content updates are reduced when using static broadcast files, the operating requirements are simplified, allowing a more cost effective deployment of a large number of applications.

In accordance with one aspect of the present invention, the system is adapted to interface seamlessly with either a suitable system projector or an embedded solution HTTP extension, to provide a complete HTTP-based environment for handling transactions over the return path. This enables a wide range of transactional iTV applications, including voting during a television program, ordering a catalogue during an enhanced television advertisement and buying goods and services from a shopping channel.

Advantageously, the present invention saves time and effort over conventional systems. Applications consist of pages built using presentation templates defined in XML by application designers. Graphic designers, using standard graphic design tools, may easily create media assets that are then easily linked into applications, ready for broadcast. Data and presentation are clearly separated for easy application maintenance and simplified integration with existing data sources. The data elements and the presentation templates are merged using standard web dynamic page building tools. Built-in text formatting features allow authoring features for international character sets. To provide maximum flexibility, developers may also use the proprietary scripting language to develop new productions that can be reused across the system based applications.

Deploying iTV applications in combination with the present invention provides additional cost savings. Integration with a screen interactive runtime application may be done once for all proprietary system based applications deployed on a network, which simplifies the application-testing phase. Integration with content sources and transaction servers relies on standard protocols, allowing for fast and reliable implementation. It is also contemplated to provide a broadcast version for network operators which also includes an unlimited development environment.

The present invention includes the ability to combine and present media in a way never experienced before by adding synchronized rich interactive commentaries to traditional media, utilizing software which uses a web browser or other media window to present dynamic interactive content, timed to another media channel.

The system software is preferably an open architecture, using existing web standards, including interactive broadcast medium, broadcast interactive media and content which can be custom made using traditional web design tools, or drawn from existing web assets. The present invention provides for real time live event messaging, which eliminates Internet streaming media timing delays, and provides for screen video on demand interactive language and platform using a switch for live realtime control software.

The present invention is adapted to enhance specialty, documentary, feature film, specials, news, weather, sports, drama, reality television, gameshow, awards show, countdown, shopping, talk show and infotainment genres, while other traditional live radio and television broadcasters, film makers, web portals, artists, designers, online retailers, search engines and content owners may also benefit from the system's synchronized enhanced media software.

In a preferred embodiment, the system is such that for the viewer or end user, the software specific to an application or group of applications is downloaded, saving unnecessary time searching, finding and remembering the information the end user is interested in.

Traditionally, radio and television networks only have a 30 second commercial advertisement inventory to offer their clients. The present invention increases their ad inventory beyond the traditional 30 second spot, while fitting into and enhancing complementary web initiatives.

In accordance with a preferred embodiment of the present invention, there is provided a platform based on a synchronized broadcasting technology that allows producers to broadcast relevant web URL's (for example., show-related trivia and other information, searches, and advertising) to viewers' internet browsers in synchronization with a television or radio show or other primary media channel content. In order to experience enhanced broadcasts based on the platform, the end user or viewer downloads a zero-install, small-client player, for example called the “Projector,” which receives URL data from a remote server running the platform's broadcaster software and points an end user's web browser to the specified web pages. Viewers may choose from two broadcast “modes,” designed to support live broadcast programming and VOD/PVR programming respectively. To ensure speedy delivery of web pages during a live program, the platform allows producers to download and cache multimedia content including graphics and text from web pages to viewers' computers before they are displayed.

In accordance with the above embodiment, in order to enhance broadcasts using the platform, the system employs a tool, for example called a “Switch,” that allows producers to 1) enter the URL's they wish to use into fields in the sequence in which they will be delivered to, viewers' computers, and 2) schedule the times at which those URL's will be automatically delivered. Alternatively, for live broadcasts, such as sports, producers can trigger the delivery of each URL manually. Once a list of URL's, complete with timing notations, has been created, it is then uploaded to the server for broadcast. In a preferred embodiment, the Projector player may also include a scoreboard-style message window that allows broadcasters to give live text updates with minimal delay time.

Various issues and disadvantages of existing systems had to be addressed. A primary aspect is to develop a simulcast internet media distribution system that could broadcast supplementary web pages and video pages in synchronization with a regular television or radio broadcast or other primary media channel content, and preferably the distribution mechanism stays in synchronization within one second over a period of one hour.

With regard to standard broadcasting, a first limitation is the inability to have constant synchronization between the television broadcast signal and the new media signal. These two signals are distributed through two entirely different communication networks. The television signal is distributed through the television station's master control and the media signal is broadcast through the internet. It was found that the streaming mechanisms used to distribute simulcast media to the client suffered from unacceptable drift. Similar limitations apply with respect to radio broadcasting. As the simulcast media needed to stay in synchronization within one second or so, the buffering and drift inherent in these existing Internet streaming technologies needs to be overcome.

In developing the present system, it was determined that a second supplementary synchronized internet media signal could be broadcasted alongside with television or radio broadcasts or other primary media channel content. The challenge with this medium is the synchronization issues to keep the two signals within one second of each other. The creation of a supplementary media stream was achieved through the building of an interface on top of the existing streaming media protocols such as RealAudio™ and Window Media™ player.

In another aspect of the present invention to provide a realtime web page broadcasting engine to allow comparative analysis to identify existing URLs and/or errors prior to launching an active browser in a client computer.

In another aspect of the present invention, there is provided an on-demand web page broadcasting engine (Projector) adapted to analyze two or more databases and initiate the appropriate pointers in a synchronized mode. Other issues arose with the end user or viewer when receiving information from the server to display video or pictures in synchronization with the television or radio broadcast or other primary media channel content. It was found that internet latencies were preventing clients from getting the desired content in time. To try and overcome the problems with the latency, it was found that by using, in combination with new techniques of data based pointers, cues from a server, the present system allowed for several systems to be synchronized together.

A further advantageous aspect of the current invention is that it does not require a broadcast communication channel from the primary server to the end-users computer. The update indications can be processed as a transaction initiated by the end-user's computer, vastly improving the setup, scalability and maintenance of the system.

In this invention there is provided a system for synchronizing data over the internet to viewers' Internet browsers in coordination with a primary media channel, the system comprising at least one server adapted to receive relevant data from a user's computer or other electronic device in synchronization with a primary media channel, the at least one server having a communication path-with at least one end-user computer, whereby in response to the timing of the content on the primary media channel, the at least one server distributes content update indications to the computer of the at least one user such that the content on the primary media channel and data, are synchronized with one another.

The invention also provides a method for simulcast Internet media distribution in synchronization with a primary media channel, the method comprising the steps of scheduling a program for a synchronized broadcast by a broadcasting network, creating or identifying web content pages related to the programming, indexing the timing of segments of the web content responsive to the primary media channel for showing at the same time as the specific video content, entering and saving data for showing with the live broadcast, initiating promotions from the broadcaster with regard to the upcoming program and synchronized broadcast, during broadcast of the program, sending and receiving triggers from at least one server over the internet, distributing via the at least one server, content update indications and real time information to registered users for the primary media channel, enabling connected computers to read triggers sent by the at least one server over the internet to enable dynamic change of interactive and static content thereof, pre-caching of the broadcast content including content elements and utilizing other caching algorithms to prevent overload on the at least one server and network capacity and utilizing timing mechanisms to compensate for the users' network latency or delay due to connection quality, and viewing the media channels thus, synchronized on at least one viewing device.

### BRIEF DESCRIPTION OF THE DRAWINGS

These and other aspects and advantages of the present invention will be readily apparent from the following detailed description and drawing figures in which:

FIG. 1 is a block diagram of the application architecture of the present invention; and

FIG. 2 is a representation of a televised program in synchronization with data transmitted over the internet.

### DETAILED DESCRIPTION OF THE PREFERRED EMBODIMENT

In the following detailed description various details are set forth in order to provide an understanding of the present invention. However, it will be understood by those skilled in the art that the present invention may be practised without these specific details. In other instances well known methods, procedures and components have not been described in detail.

In accordance with a preferred embodiment of the present invention, there is provided a system adapted to broadcast over the internet to a viewer's or end-user's computer or other electronic device relevant data in synchronization with a primary media channel.

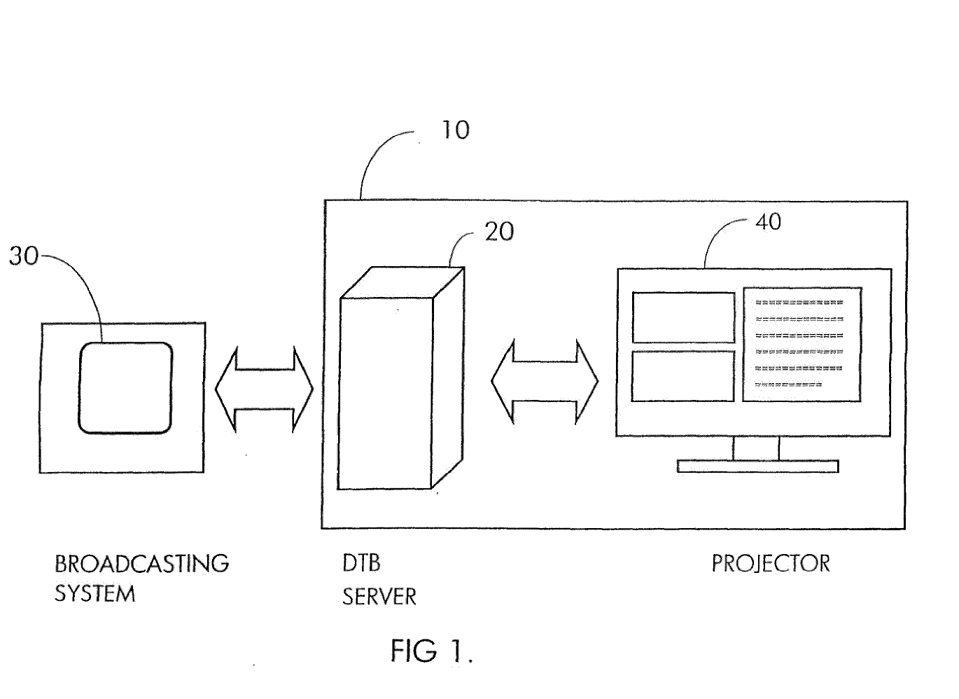

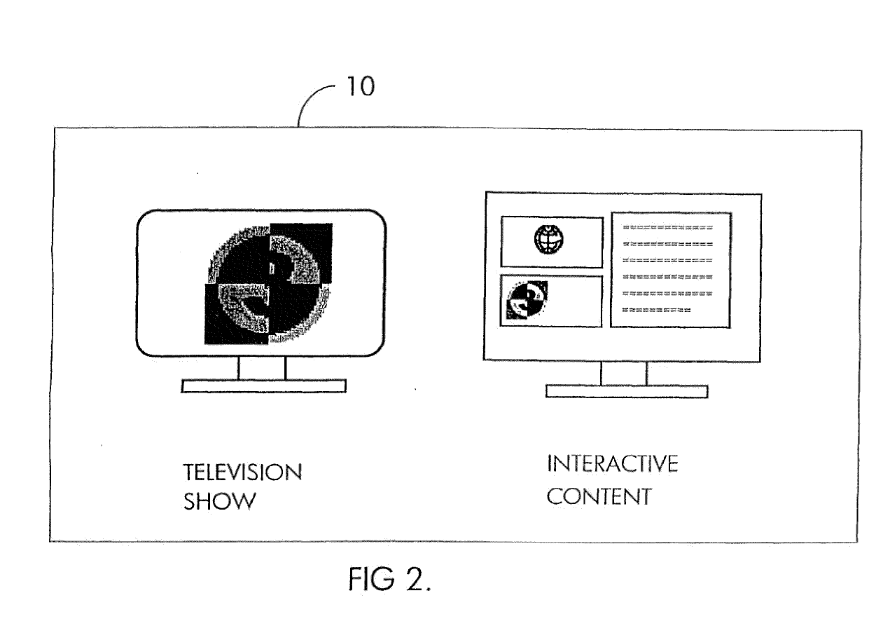

As illustrated in FIG. 1, there is provided a block diagram illustrating the simulcast or real-time internet broadcasting system architecture, generally identified as numeral 10. The system architecture includes a primary server 20, adapted to receive or be in communication with a television show broadcast 30, and an end-user or viewer program 40 (for exemplary purposes termed the projector) on the viewer's computer or other electronic device. In use, the server 20 allows for synchronized broadcasting of relevant web data such as URL's, to an end-viewer. FIG. 2 illustrates a live deployment of the system 10, with a 2 screen interactive medium, including a television show being broadcast in synchronization with Internet content being broadcast to a viewer's computer.

As contemplated, the primary server 20 is operatively associated with or in communication with both the show or television broadcast and the viewer's computer, where the primary server 20 is able to receive data from the show in synchronization (FIG. 1), whereby static broadcast files are stored and ready to broadcast through the server to the end user. Alternatively, dynamic updates or files may also be used. Multiple servers may also be used.

The present invention provides network operators, content providers and independent developers with the integrated content publishing software environment to rapidly transform standard web-based content into media rich, dynamic, broadcast ready interactive applications. This system and software combines the latest in technology with standard internet protocols, for example XML and HTTP, to create compelling interactive applications, built for multi viewport interactive television. The present invention includes a server and runtime architecture to provide the benefits of XML authoring.

The viewer experiences total engagement as the synchronized broadcast media content is presented. When an advertisement appears in the broadcast, a whole range of options can be employed to provide an eTV viewing experience beyond that of any current media including traditional television.

In a preferred embodiment, the system operates in the following manner:

1. A program is scheduled for synchronized broadcasting by the broadcast network.

2. Web content pages related to the program and advertisements are identified or created, and stored on the primary server.

3. The web content is indexed with time triggers along with the program to show at the same time as specific video content (for example, a biography of the main character in a documentary shows up as that character is introduced).

4. URLs are then entered and saved, using ShowSync software for live broadcast.

5. The broadcaster initiates promotion about the upcoming show and synchronized broadcast. Users download the synchronized broadcast player from links on the broadcasters various websites (station, program or sponsors website, etc.)

6. At broadcast time, the synchronized broadcast-ready studio is operational. During the broadcast, each trigger is sent to a primary or central server via the internet.

7. The primary server distributes content events or ‘calls’ in real-time to all users who have registered for the show, and have launched their synchronized broadcast viewer software/program.

8. An existing home computer then receives the triggers, which in turn, fetch the dynamic interactive content.

a. Pre-caching of the synchronized broadcast content elements and other intelligent caching algorithms may be employed to reduce stress on servers and network capacity.

b. Timing mechanisms compensate for the user's network latency, or delay due to variable connection quality.

9. This Internet content can be viewed in several ways, two of which are illustrated below:

a) Single computer screen—with embedded video streaming outside the synchronized broadcast viewer,

b) Dual Screen—with the broadcast on the television, and the synchronized broadcast content displayed on a nearby computer that is (either via wire or wireless) connected to the internet.

The system and software is adapted to be presented on multiple viewports simultaneously such as a television and computer screen giving viewers choice in how they interact with programming, using existing hardware and software.

Advantageously, options for content types are as vast and varied as those available on the internet. They include hyperlinks, rich media, Macromedia Flash presentations; banner advertisements, forms and HTML content pages, each with interactive opportunities related to the content.

The user can see the URLs visited in a link list. A viewer or end user can opt to click immediately, or email the link list to themselves for later review of the content. The present system synchronizes the television broadcast with websites that appear on-screen.

In use, once the television broadcast has started, the viewer can either “lean back” and watch as the broadcast and eTV content is presented automatically, or they can “lean forward” and interact at will with the content—following links, doing deeper research, filling in registration forms, entering contests or the like. When the viewer is finished interacting, a single click re-synchronizes the synchronized broadcast with the broadcast content or primary media channel.

As above, with the synchronization of broadcasts of the primary media channel and internet content, an advertiser's website can pop up at the same time their commercial spot appears on television or radio, allowing consumers to react immediately to special offers and promotions and instantly access information about new products.

With regard to specialized content or genres, sports fans can use the internet with their television or radio or other primary media channel to see the latest statistics and player profiles in parallel with the live programming—providing the most informative, up-to-date and exciting sports viewing experience.

The present system provides the advantage of enabling viewers of many genres of content to synchronize broadcast with websites or other pertinent data on their computer.

Other advantages of the present system include the ability to automatically log and save websites during the watched program. The viewer can choose to look at them before, during the program or after.

Thus, a method and system for providing synchronous data with a primary media channel has been described. Whereas modifications of the present invention may be comprehended by a person of skill in the art to which the present invention pertains, it is to be understood that the particular embodiments shown and described by way of illustration are in no way intended to be considered limiting. References to details of any particular embodiments are not intended to limit the scope of the appended claims.

What is claimed is:

1. A system for synchronizing data over the Internet to viewers' Internet browsers in coordination with a primary media channel, the system comprising:
at least one server adapted to receive relevant data from a user's computer or other electronic device in synchronization with a primary media channel, said at least one server having a communication path with at least one end-user computer, whereby in response to the timing of the content on the primary media channel, the at least one server distributes content update indications to the computer of the at least one user such that the content on the primary media channel and data are synchronized with one another.

2. The system of claim 1 wherein the primary media channel is a broadcast television or radio program.

3. The system of claim 1 or 2 wherein the data is from multiple supplementary media channels.

4. The system of any one of claims 1, 2 or 3 wherein the synchronization is near one second.

5. The system of any one of claims 1, 2 or 3 wherein the synchronization is less than one second.

6. The system of any one of claims 1 to 5 wherein the content update indications comprise dynamic content updates or static broadcast files.

7. The system of any one of claims 1 to 6 wherein the computer of the at least one user includes software specific to the content on the primary media channel to receive the content update indications from the at least one server.

8. A method for simulcast Internet media distribution in synchronization with a primary media channel, the method comprising the steps of:
scheduling a program for a synchronized broadcast by a broadcasting network;
creating or identifying web content pages related to the programming;
indexing the timing of segments of the web content responsive to the primary media channel for showing at the same time as the specific video content;
entering and saving data for showing with the live broadcast;
initiating promotions from the broadcaster with regard to the upcoming program and synchronized broadcast;
during broadcast of the program, sending and receiving triggers from at least one server over the Internet;
distributing via the at least one server, content update indications and real time information to registered users for the primary media channel;
enabling connected computers to read triggers sent by said at least one server over the internet to enable dynamic change of interactive and static content thereof;
pre-caching of the broadcast content including content elements and utilizing other caching algorithms to prevent overload on said at least one server and network capacity and utilizing timing mechanisms to compensate for the users' network latency or delay due to connection quality;
and viewing the media channels thus synchronized on at least one viewing device.

9. The method of claim 8 wherein the primary media channel is a broadcast television or radio program.

10. The method of claim 8 or 9 wherein the data is from multiple supplementary media channels.

11. The method of any one of claims 8, 9 or 10 wherein the synchronization is near one second.

12. The method of any one of claims 8, 9 or 10 wherein the synchronization is less than one second.

13. The method of any one of claims 7 to 12 wherein the content update indications comprise dynamic content updates or static broadcast files.

14. The method of any one of claims 7 to 12 further comprising the step of downloading software specific to the content on the primary media channel to said connected computers to receive content update indications from the at least one server.
